(19) United States
(12) Patent Application Publication
(10) Pub. No.: US 2011/0004900 A1
(43) Pub. Date: Jan. 6, 2011

(54) CHANNEL NAVIGATION METHODS AND APPARATUS FOR NAVIGATING A PLURALITY OF AUDIO/VIDEO BROADCASTING CHANNELS

(76) Inventor: Jinlong Li, Anhui Province (CN)

Correspondence Address: NORTH AMERICA INTELLECTUAL PROPERTY CORPORATION, P.O. BOX 506, MERRIFIELD, VA, 22116, US

(21) Appl. No.: 12/920,111

(22) PCT Filed: Dec. 30, 2008
(86) PCT No.: PCT/CN08/73845

§ 371 Date: Aug. 30, 2010

(51) Int. Cl. H04N 5/445

(52) U.S. Cl. 725/38

(57) ABSTRACT

A channel navigation method for navigating a plurality of audio/video broadcasting channels includes: grouping the audio/video broadcasting channels into a plurality of groups; and providing a user interface module for selecting one of the groups to select an audio/video broadcasting channel within the selected group. A channel navigation apparatus for navigating a plurality of audio/video broadcasting channels includes: a processing circuit for grouping the audio/video broadcasting channels into a plurality of groups; and a user interface module, coupled to the processing circuit, for selecting one of the groups to select an audio/video broadcasting channel within the selected group.

### FIELD OF INVENTION

The present invention relates to digital television (DTV), and more particularly, to channel navigation methods and apparatus for navigating a plurality of audio/video broadcasting channels.

### BACKGROUND OF THE INVENTION

According to the related art, when a user navigates television (TV) channels to find a specific channel for viewing, the user typically needs to search for the specific channel by switching from one channel to a subsequent channel repeatedly and sequentially within at least a portion of the channels. As long as the user memorizes the channel number of the specific channel, the corresponding searching time can be greatly saved by directly switching from a current channel to the specific channel. As the number of channels increases, it is more difficult for the user to memorize the channel numbers of all the channels that the user is interested in. Thus, according to the conventional TV channel navigation scheme, it is exceedingly difficult to reduce the time that a normal user must spend navigating channels.

Some related art methods are therefore proposed to relieve the pain of spending a lot of time navigating channels. For example, according to one related art method, a user may enter the channel name for a searching purpose. However, there is not much space available on a remote control module such as an infrared (IR) remote controller, and the number of keys on the IR remote controller is limited, causing a troublesome operation of entering the channel name.

Moreover, in a situation where entering Chinese characters is required for the same searching purpose, the drawbacks of using the related art method will be greater than usual, since it is an unacceptable burden for most users to be familiarized with or even to learn a new Chinese character input method customized for the limited number of keys on the IR remote controller.

### SUMMARY OF THE INVENTION

It is therefore an objective of the claimed invention to provide channel navigation methods and apparatus for navigating a plurality of audio/video broadcasting channels to solve the above-mentioned problems.

It is another objective of the claimed invention to provide channel navigation methods and apparatus for navigating a plurality of audio/video broadcasting channels, in order to efficiently organize the audio/video broadcasting channels.

It is another objective of the claimed invention to provide channel navigation methods and apparatus for navigating a plurality of audio/video broadcasting channels, so that the audio/video broadcasting channels can be easily navigated by a user who is looking for a channel to view.

An exemplary embodiment of a channel navigation method for navigating a plurality of audio/video broadcasting channels comprises: grouping the audio/video broadcasting channels into a plurality of groups; and providing a user interface module for selecting one of the groups to select an audio/video broadcasting channel within the selected group.

An exemplary embodiment of a channel navigation apparatus for navigating a plurality of audio/video broadcasting channels comprises: a processing circuit for grouping the audio/video broadcasting channels into a plurality of groups; and a user interface module, coupled to the processing circuit, for selecting one of the groups to select an audio/video broadcasting channel within the selected group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a channel navigation apparatus for navigating a plurality of audio/video broadcasting channels according to a first embodiment of the present invention.

FIG. 2 illustrates an exemplary arrangement scheme of a plurality of keys within the keypad shown in FIG. 1 according to one embodiment of the present invention.

FIG. 3 illustrates information displayed on the display panel shown in FIG. 1 in respective phases during a manual operation of grouping one of the audio/video broadcasting channels into a specific group according to one embodiment of the present invention, where the manual operation is triggered when a first pre-defined button such as a function key shown in FIG. 2 is pressed.

FIG. 4 illustrates information displayed on the display panel shown in FIG. 1 in respective phases during a selection operation according to one embodiment of the present invention, where the selection operation is triggered when a second pre-defined button such as another function key shown in FIG. 2 is pressed.

FIG. 5 is a diagram of a channel navigation apparatus for navigating a plurality of audio/video broadcasting channels according to a second embodiment of the present invention, where the second embodiment is a variation of the first embodiment.

FIG. 6 and FIG. 7 respectively illustrate exemplary grouping schemes utilized in a channel navigation method applied to the channel navigation apparatus shown in FIG. 5 according to one embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention provides channel navigation methods for navigating a plurality of audio/video broadcasting channels, where corresponding channel navigation apparatus for navigating the audio/video broadcasting channels are also provided. According to some embodiments of the present invention, the audio/video broadcasting channels are digital television (DTV) channels, and the channel navigation methods are applied to a DTV receiver or a DTV. In these embodiments, one channel navigation apparatus typically represents at least a portion of a DTV receiver or at least a portion of a DTV, and is positioned within the DTV receiver or the DTV. For example, the channel navigation apparatus may represent a portion of a DTV receiver or a portion of a DTV. In another example, the channel navigation apparatus may represent a whole DTV receiver or a whole DTV.

According to variations of these embodiments, the channel navigation apparatus may represent at least a portion of a multi-function electronic device having the DTV receiver function or the DTV function. For example, the channel navigation apparatus may represent a portion of a handheld multi-function device such as a cellular phone or a personal digital assistant (PDA) that has the DTV function. In another example, the channel navigation apparatus may represent a whole handheld multi-function device such as a cellular phone or a PDA that has DTV functionality.

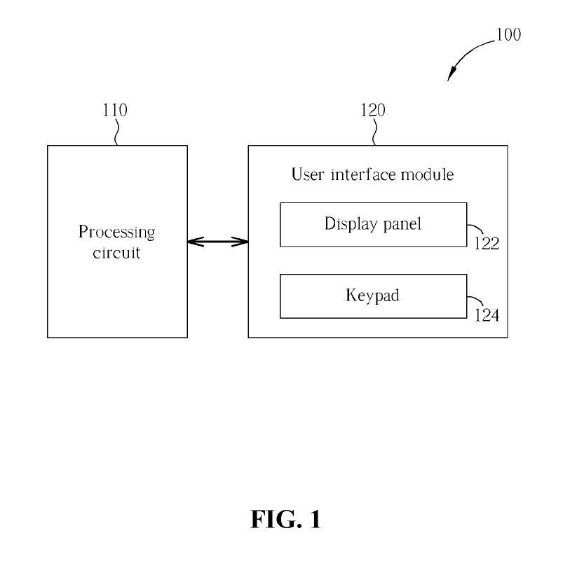

Please refer to FIG. 1. FIG. 1 is a diagram of a channel navigation apparatus 100 for navigating a plurality of audio/video broadcasting channels according to a first embodiment of the present invention, where the audio/video broadcasting channels of this embodiment are DTV channels, and the channel navigation apparatus 100 is positioned within a DTV receiver or a DTV. As shown in FIG. 1, the channel navigation apparatus 100 comprises a processing circuit 110 and a user interface module 120.

In this embodiment, the processing circuit 110 is utilized for grouping the audio/video broadcasting channels into a plurality of groups, and the user interface module 120 is utilized for selecting one of the groups to select an audio/video broadcasting channel within the selected group. In practice, the processing circuit 110 can be implemented with a core circuit for controlling the whole DTV receiver or the whole DTV. According to a first implementation choice of this embodiment (i.e., a special case of this embodiment), the processing circuit 110 can be a micro-processing unit (MPU) executing a program code such as a firmware code. According to a second implementation choice of this embodiment (i.e., another special case of this embodiment), the processing circuit 110 can be a controller executing a hardware code.

According to this embodiment, the user interface module 120 comprises a display panel 122, such as a liquid crystal display (LCD) panel or an organic light emitting diode (OLED) display panel. In addition, regarding implementation of a plurality of pre-defined buttons and numeric buttons within the user interface module 120 for user control purposes, the user interface module 120 further comprises a keypad 124, where the keypad 124 of this embodiment comprises a plurality of keys.

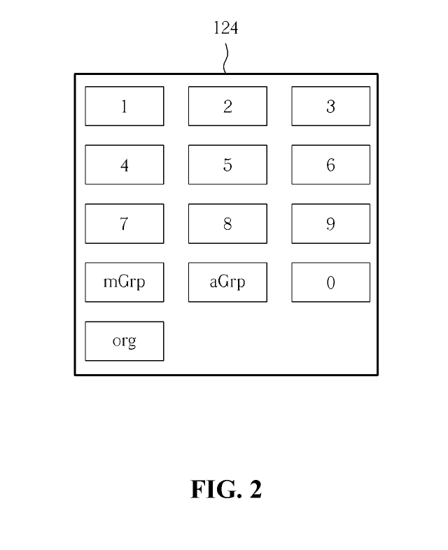

FIG. 2 illustrates an exemplary arrangement scheme of the plurality of keys within the keypad 124 shown in FIG. 1 according to one embodiment of the present invention. Here, the keys “mGrp”, “aGrp”, and “org” represent the pre-defined buttons mentioned above, and the keys 0-9 represent the numeric buttons mentioned above. Although the pre-defined buttons and the numeric buttons are implemented with the keys within the keypad 124, this is not a limitation of the present invention.

According to a variation of the first embodiment, the pre-defined buttons and the numeric buttons can be implemented with individual buttons instead of the keys within the keypad 124. According to another variation of the first embodiment, the pre-defined buttons and the numeric buttons can be implemented with virtual buttons of a touch panel or a touch pad. According to yet another variation of the first embodiment, the numeric buttons can be replaced with some directional control architecture such as that on a game pad or that on a joystick, in order to switch from one item to another on the display panel.

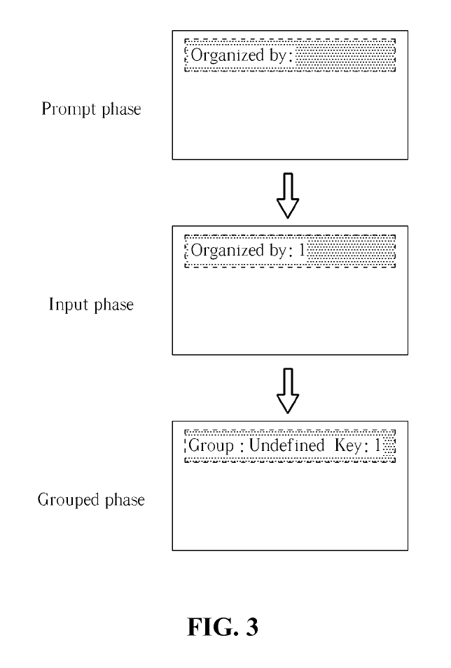

FIG. 3 illustrates information displayed on the display panel 122 shown in FIG. 1 in respective phases during a manual operation of grouping one of the audio/video broadcasting channels into a specific group of the groups according to one embodiment of the present invention, where the manual operation is triggered when a first pre-defined button such as the function key “org” shown in FIG. 2 is pressed. Here, the manual operation can be referred to as the manual grouping operation.

According to this embodiment, when a user presses the function key “org” shown in FIG. 2, a prompt phase is entered, and the user is prompted with a message such as “Organized by:” as shown in FIG. 3. In addition, when the user presses the numeric key “1” shown in FIG. 2, an input phase is entered, and a current channel of the audio/video broadcasting channels (e.g., a currently displayed channel) is grouped into a specific group represented by the numeric key “1” rather than any other group represented by another numeric key of the keypad 124. Immediately, a grouped phase is entered, and the user is prompted with a message such as “Group: Undefined Key: 1” as shown in FIG. 3, since the user has not entered/edited the name of the specific group.

It should be noted that in the input phase mentioned above, each numeric key of the keypad 124 of this embodiment represents a register within the processing circuit 110. As values in registers for the grouping purpose within the processing circuit 110 can be altered, the audio/video broadcasting channels can be re-grouped when needed. In addition, in this embodiment, the name of each group is associated with the corresponding register, and can be edited when needed.

According to a variation of this embodiment, the input phase is extended, so that the user may enter/edit the name of the specific group before the grouped phase is entered.

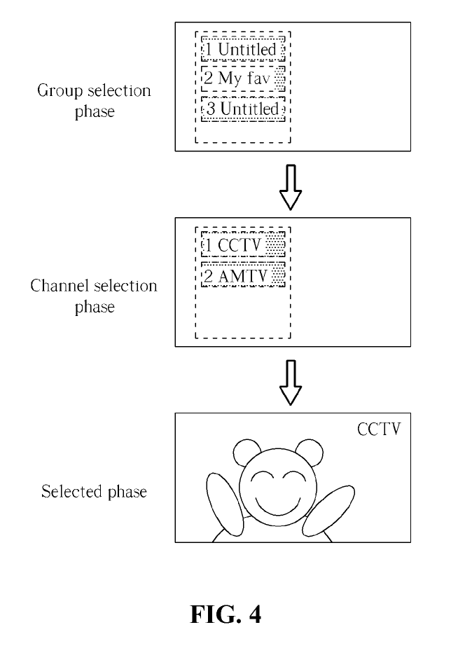

FIG. 4 illustrates information displayed on the display panel 122 shown in FIG. 1 in respective phases during a selection operation according to one embodiment of the present invention, where the selection operation is triggered when a second pre-defined button such as the function key “mGrp” shown in FIG. 2 is pressed. When the user presses the function key “mGrp”, a group selection phase is entered, and at least a portion of groups such as a first group named “untitled”, a second group named “My fav”, and a third group named “untitled” are displayed on the display panel 122 shown in FIG. 1. In this embodiment, as the names of the groups can be edited, the second group has been renamed as “My fav” which means “My favorite channels” with the first and the third groups remaining untitled. When the user presses the numeric key “2” shown in FIG. 2, the second group named “My fav” is selected as the selected group, and a channel selection phase is entered. In the channel selection phase, some of the audio/video broadcasting channels that were previously grouped into the second group named “My fav” by pressing the numeric key “2” after the function key “org” is pressed (e.g., a first channel named “CCTV” and a second channel named “AMTV” shown in FIG. 4) are displayed on the display panel 122. After the user selects one of the channels in the selected group, for example, the user presses the numeric key “1” in the channel selection phase, a selected phase is entered, and the display panel 122 displays the video content of the selected channel, i.e., the channel named “CCTV” in this situation.

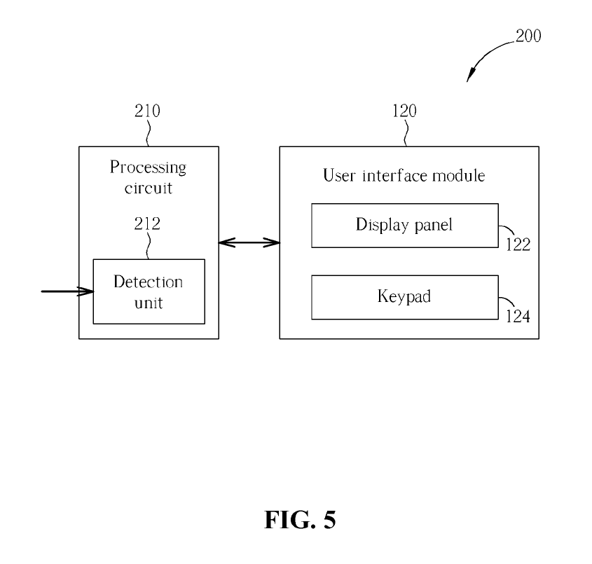

FIG. 5 is a diagram of a channel navigation apparatus 200 for navigating a plurality of audio/video broadcasting channels according to a second embodiment of the present invention, where the second embodiment is a variation of the first embodiment. Differences between the second embodiment and the first embodiment are described as follows.

As shown in FIG. 5, the aforementioned processing circuit 110 is replaced with another processing circuit 210 comprising a detection unit 212, which is embedded in the processing circuit 210 in this embodiment. In addition to the manual grouping operation as performed by the processing circuit 110 mentioned above, the processing circuit 210 is capable of performing an automatic grouping operation.

According to this embodiment, the detection unit 212 is utilized for detecting specific data respectively corresponding to the audio/video broadcasting channels, where the specific data is carried by at least one signal transmitted through at least one audio/video broadcasting channel of the audio/video broadcasting channels. According to the specific data respectively corresponding to the audio/video broadcasting channels, the processing circuit 210 automatically groups the audio/video broadcasting channels into the plurality of groups.

In addition, the detection unit 212 may detect a signal transmitted through one of the audio/video broadcasting channels to determine whether at least one value of the specific data corresponding to a specific audio/video broadcasting channel is varied. When the specific data corresponding to the specific audio/video broadcasting channel is varied, the processing circuit 210 groups the specific audio/video broadcasting channel into one of the groups according to the latest value(s) of the specific data. Thus, the grouping status of all the audio/video broadcasting channels can be continuously maintained.

In this embodiment, the channel navigation apparatus 200 complies with specific digital terrestrial TV broadcasting (DTTB) standards, such as: USA-based Advanced Television Systems Committee (ATSC) standards, European-based Digital Video Broadcasting-Terrestrial (DVB-T) standards, Japan-based Integrated Services Digital Broadcasting (ISDB) standards, and/or China-based Digital Television/Terrestrial Multimedia Broadcasting (DTMB) standards. In addition, the aforementioned specific data may represent service information (SI) data or transport stream information (TSI) data defined in at least one of the standards. In this embodiment, the SI data or the TSI data are utilized in a different purpose than in these standards, in order to perform the automatic grouping operation.

The processing circuit 210 of this embodiment gathers the SI data and/or the TSI data in a database within the channel navigation apparatus 200. For example, the database can be positioned in an external memory outside the processing circuit 210 or an internal memory of the processing circuit 210. According to this embodiment, the database comprises some data fields, where a data field can be specified for the automatic grouping operation, and those audio/video broadcasting channels having the same value in this data field will be organized in the same group.

In this embodiment, the user interface module 120 comprises a third pre-defined button for triggering the selection of a selected group of a plurality of groups derived from the automatic grouping operation. Here, the third pre-defined button of this embodiment is implemented with the function key “aGrp”, as shown in FIG. 2. Once the selection corresponding to the groups derived from the automatic grouping operation is triggered, the user may select a group from these groups and then select one of those audio/video broadcasting channels that were previously grouped into this selected group.

In practice, when one of the aforementioned first or second implementation choices of the first embodiment is applied to the processing circuit 210 of the second embodiment, the detection unit 212 can be a logically defined component of the processing circuit 210. That is, the detection unit 212 may represent a portion of code of the processing circuit 210; for example, a portion of a firmware code or a portion of a hardware code. It should be noted that these implementation choices are not limitations of the present invention. According to a variation of the second embodiment, the detection unit 212 can also be an individual component within the channel navigation apparatus 200.

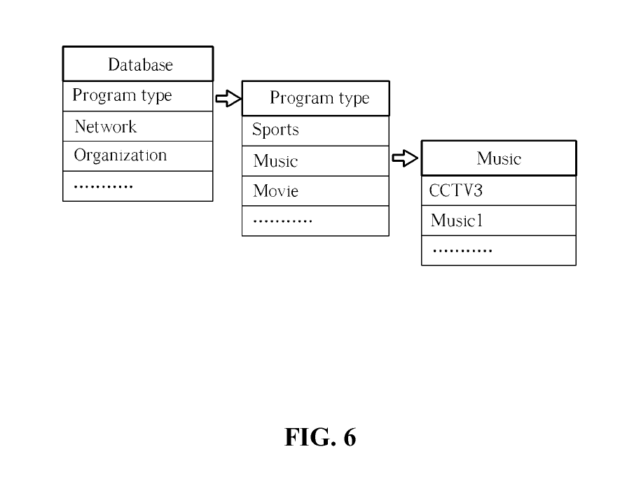

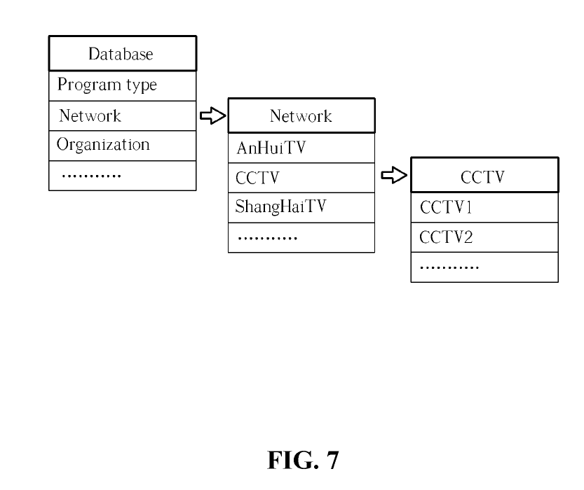

FIG. 6 and FIG. 7 respectively illustrate exemplary grouping schemes utilized in a channel navigation method applied to the channel navigation apparatus 200 shown in FIG. 5 according to one embodiment of the present invention, where most detailed steps of the channel navigation method have been disclosed through the operations of the channel navigation apparatus (e.g., the channel navigation apparatus 100 and the channel navigation apparatus 200) in the embodiments and variations described above. It should be noted that these grouping schemes are based on the automatic grouping operation mentioned above, and can be updated in real time according to the SI data and/or the TSI data.

As shown in FIG. 6, an audio/video broadcasting channel named “CCTV3” and an audio/video broadcasting channel named “Music 1” were previously grouped into a sub-group named “Music” within a group “Program type”. Here, the name “Program type” means sub-groups within the group “Program type” are classified according to program types that are determined by the processing circuit 210, where the processing circuit 210 determines the program types according to the SI data and/or the TSI data detected by the detection unit 212.

In addition, as shown in FIG. 7, an audio/video broadcasting channel named “CCTV1” and an audio/video broadcasting channel named “CCTV2” were previously grouped into a sub-group named “CCTV” within a group named “Network”. Here, the name “Network” means sub-groups within the group “Program type” are classified according to network types that are determined by the processing circuit 210, where the processing circuit 210 determines the network types according to the SI data and/or the TSI data detected by the detection unit 212.

According to a variation of the second embodiment, by analyzing channel navigation history of at least one user (i.e., one or more users), the processing circuit 210 repeatedly rearranges the order of items displayed on the display panel 122, so that the most frequently selected items (e.g., groups, sub-groups, and audio/video broadcasting channels) are displayed first in respective menus for being easily selected.

According to another variation of the second embodiment, by analyzing the channel navigation history and channel viewing history of at least one user, the processing circuit 210 repeatedly rearranges the order of items displayed on the display panel 122, so that the most frequently selected/viewed items (e.g., the most frequently selected groups, sub-groups, and audio/video broadcasting channels and the most frequently viewed audio/video broadcasting channels) are displayed first in respective menus for being easily selected.

Furthermore, in current television broadcasting streams, “program type” is a special parameter having a value that is changed over time but other parameters are usually fixed. For example, a television channel may broadcast “comics” television programs during 14:00 to 15:00 but play music during 15:00 to 16:00. Therefore, an improved group list may include “program type” in addition to channel name, because such arrangement provides more useful information. In fact, other parameters may also be viewed just by adding these parameters into the group list, to provide users even more information. In addition, a group list that shows grouping results in an interface as explained above may also use future parameters. For example, on analyzing current parameters from a television broadcasting stream, a television channel may not be selected because the television channel does not broadcast a “comics” television program now. The television channel, however, may broadcast a “comics” television program two hours later. By reference to future parameter, e.g. from analyzing EPG, the television channel may be on the group list configured by a user as mentioned above. Further, the user may book the “comics” television program two hours later so that the television switches to the television channel automatically when the television channel starts broadcasting the “comics” television program.

Another embodiment of the present invention is to provide users capability to save configuration, e.g. group list, in a television apparatus so that users do not need to repeatedly input configuration just for getting channels being grouped. The saved configuration may appear in a television interface as shortcuts that may be selected via a remote control.

It is an advantage of the present invention that when the present invention methods and apparatus are widely applied to TV/DTV receivers, TV/DTVs, and electronic device having the DTV receiver function or the DTV function, and so on, the total time that users spend navigating channels is greatly saved. Therefore, the overall performance of digital broadcasting technologies is empowered, bringing billions of customers the excellent watching experience never realized before from watching TV/DTV implemented according to the related art.

Those skilled in the art will readily observe that numerous modifications and alterations of the device and method may be made while retaining the teachings of the invention.

1. A channel navigation method for navigating a plurality of audio/video broadcasting channels, comprising:
grouping the audio/video broadcasting channels into a plurality of groups; and
providing a user interface module for selecting one of the groups to select an audio/video broadcasting channel within the selected group.

2. The channel navigation method of claim 1, wherein the audio/video broadcasting channels are digital television (DTV) channels, and the channel navigation method is applied to a DTV receiver or a DTV.

3. The channel navigation method of claim 1, wherein the step of grouping the audio/video broadcasting channels into the plurality of groups further comprises:
detecting specific data respectively corresponding to the audio/video broadcasting channels, wherein the specific data is carried by at least one signal transmitted through at least one audio/video broadcasting channel; and
automatically grouping the audio/video broadcasting channels into the plurality of groups according to the specific data respectively corresponding to the audio/video broadcasting channels.

4. The channel navigation method of claim 3, wherein the specific data represents service information (SI) data and/or transport stream information (TSI) data.

5. The channel navigation method of claim 3, wherein the user interface module comprises a display device; and the channel navigation method further comprises:
by analyzing channel navigation history and/or channel viewing history of at least one user, rearranging the order of items displayed by the display device, so that the most frequently selected/viewed items are displayed first in respective menu(s).

6. The channel navigation method of claim 3, further comprising:
detecting a signal transmitted through one of the audio/video broadcasting channels to determine whether at least one value of the specific data corresponding to a specific audio/video broadcasting channel is varied; and
when the specific data corresponding to the specific audio/video broadcasting channel is varied, grouping the specific audio/video broadcasting channel into one of the groups according to the latest value(s) of the specific data.

7. The channel navigation method of claim 3, further comprising:
within the user interface module, providing a pre-defined button for triggering the selection of the selected group.

8. The channel navigation method of claim 1, further comprising:
within the user interface module, providing a first pre-defined button for triggering a manual operation of grouping one of the audio/video broadcasting channels into a specific group of the groups.

9. The channel navigation method of claim 8, further comprising:
within the user interface module, providing a numeric button representing the specific group; and
when the numeric button is pressed after the first pre-defined button is pressed, grouping the audio/video broadcasting channel into the specific group.

10. The channel navigation method of claim 9, further comprising:
within the user interface module, providing a second pre-defined button for triggering the selection of the selected group; and
when the numeric button is pressed after the second pre-defined button is pressed, selecting the specific group as the selected group.

11. A channel navigation apparatus for navigating a plurality of audio/video broadcasting channels, comprising:
a processing circuit for grouping the audio/video broadcasting channels into a plurality of groups; and
a user interface module, coupled to the processing circuit, for selecting one of the groups to select an audio/video broadcasting channel within the selected group.

12. The channel navigation apparatus of claim 11, wherein the audio/video broadcasting channels are digital television (DTV) channels, and the channel navigation apparatus is positioned within a DTV receiver or a DTV.

13. The channel navigation apparatus of claim 11, wherein the processing circuit comprises:
a detection unit for detecting specific data respectively corresponding to the audio/video broadcasting channels, wherein the specific data is carried by at least one signal transmitted through at least one audio/video broadcasting channel;
wherein the processing circuit automatically groups the audio/video broadcasting channels into the plurality of groups according to the specific data respectively corresponding to the audio/video broadcasting channels.

14. The channel navigation apparatus of claim 13, wherein the specific data represents service information (SI) data and/or transport stream information (TSI) data.

15. The channel navigation apparatus of claim 13, wherein by analyzing channel navigation history and/or channel viewing history of at least one user, the processing circuit rearranges the order of items displayed by a display device of the user interface module, so that the most frequently selected/viewed items are displayed first in respective menu(s).

16. The channel navigation apparatus of claim 13, wherein the detection unit detects a signal transmitted through one of the audio/video broadcasting channels to determine whether at least one value of the specific data corresponding to a specific audio/video broadcasting channel is varied; and when the specific data corresponding to the specific audio/video broadcasting channel is varied, the processing circuit groups the specific audio/video broadcasting channel into one of the groups according to the latest value(s) of the specific data.

17. The channel navigation apparatus of claim 13, wherein the user interface module comprises:
a pre-defined button for triggering the selection of the selected group.

18. The channel navigation apparatus of claim 11, wherein the user interface module comprises:
a first pre-defined button for triggering a manual operation of grouping one of the audio/video broadcasting channels into a specific group of the groups.

19. The channel navigation apparatus of claim 18, wherein the user interface module further comprises:
a numeric button representing the specific group;
wherein when the numeric button is pressed after the first pre-defined button is pressed, the audio/video broadcasting channel is grouped into the specific group.

20. The channel navigation apparatus of claim 19, wherein the user interface module further comprises:
a second pre-defined button for triggering the selection of the selected group;
wherein when the numeric button is pressed after the second pre-defined button is pressed, the specific group is selected as the selected group.
